(19) United States
(12) Patent Application Publication
(10) Pub. No.: US 2011/0118387 A1
(43) Pub. Date: May 19, 2011

(54) SEALER COMPOSITIONS

(75) Inventors: Daniel P. Sophiea, Lake Orion, MI (US); Geng Lin, Rochester Hills, MI (US)

(73) Assignee: Dow Global Technologies Inc., Midland, MI (US)

(21) Appl. No.: 13/014,586

(22) Filed: Jan. 26, 2011

Related U.S. Application Data
(63) Continuation of application No. 11/138,541, filed on May 26, 2005, now abandoned.

(51) Int. Cl. C08G 59/18; C08K 5/12; C08K 5/09

(52) U.S. Cl. 523/455; 528/369; 523/400; 528/119

(57) ABSTRACT

A PVC-free plastisol composition is provided. The sealer comprises a one-component, PVC-free plastisol embodied in a hybrid epoxy-urethane composition. Alternatively, the sealer may be embodied in a hybrid epoxy-urethane-acrylic composition. The composition comprises a urethane component, an epoxy component, a curing agent and a catalyst. The composition my further comprise a solvent and a filler. An acrylic additive may also be used. The compositions may find broad use in any system that is baked at an elevated temperature.

### CROSS-REFERENCE TO RELATED APPLICATION

This application is a continuation of U.S. application Ser. No. 11/138,541 filed May 26, 2005, the entire contents of which is incorporated herein by reference.

### FIELD OF THE INVENTION

The present invention relates to a sealer for use in vehicle production. More particularly, the present invention relates to a heat curable PVC-free material having a relatively long shelf life for use in sealing vehicles including, automobiles, buses, trucks and other applications requiring excellent adhesion to e-coated substrates, high exterior weather resistance, abrasion resistance and chip resistance.

### BACKGROUND OF THE INVENTION

The use of PVC-based bulk materials and components in the construction of vehicles is well known. Polyvinyl chloride resins, suspension, dispersion or emulsion grades are commonly dispersed in liquid plasticizers (with other additives) to form a plastisol. The plastisol composition is thermoplastic and requires heat and time for fusion. Materials which use PVC have proven cost effective in production and resilient in use.

However, for all of their recognized advantages, the production and use of PVC-based materials also carry noteworthy disadvantages. For example, current PVC plastisols have a shelf life of between 60 and 90 days due to their inherent gelling mechanism. This is because PVC plastisols are formed through the fusion of PVC and the plasticizer, an event that occurs rapidly at an elevated temperature but nevertheless proceeds more slowly at room temperature. Furthermore, PVC-based plastisols are alleged to present challenges to our environment and health. Environmental concern starts with the production of PVC, wherein the precursor monomer, vinyl chloride, a volatile, toxic gas is released to the atmosphere and also concerns have risen regarding the recycling or incineration of PVC-based materials. During incineration, toxic hydrochloric acid is released, resulting in acid rain and smog. Another component of PVC plastisols that is a concern for the environment is the plasticizer component. Some common plasticizers used in PVC plastisols are being banned globally due to their ability to mimic hormones in the human body, especially young children.

Certain steps have been taken to overcome the deficiencies of PVC-based components and bulk materials by replacing them with products having similar cost and performance characteristics but which do not rely upon PVC as a component. Such efforts include the use of acrylic chemistry with urethane or polyamide adhesion promoters. The use of prepolymers of urethanes and epoxy resins is also known. However, such materials are too high in viscosity to process in paint shop materials. Accordingly, it is desirable to produce a PVC-free composition having application in many areas of vehicle production, particularly in the areas of vehicle sealing and damping.

### SUMMARY OF THE INVENTION

According to one embodiment of the present invention, there is provided a composition adapted for use as a sealer comprising a urethane component. The composition further comprises an epoxy component. Additionally, the composition comprises a curing agent component and a catalyst component.

According to a second embodiment of the present invention, there is provided a composition adapted for use as a sealer comprising a blocked urethane component in the range of between about 11% and about 22% by weight. The composition further comprises an epoxy component in the range of between about 5% and about 15% by weight. A powdered acrylic component is provided in the range of between about 5% and about 25% by weight. The composition further comprises a powdered amine component in the range of between about 0.1% and about 5% by weight.

### DETAILED DESCRIPTION OF THE PREFERRED

### Embodiments of the Invention

The present invention provides a PVC-free sealer that finds broad and versatile application as a sealer. The invention is particularly useful in the automotive sector. Preferably, the sealer is a one-component, PVC-free plastisol embodied in a hybrid epoxy-urethane composition. Alternatively, the sealer may be embodied in a hybrid epoxy-urethane-acrylic composition. Sealer application could include most, if not all paint shop and body shop applications. Nevertheless, the present compositions are particularly useful in high temperature baking applications such as those employed in automotive paint shop conditions. Given the versatility of the present compositions, application could be had in many areas of vehicle production, generally in the areas of vehicle sealing and damping. More particular applications would be in the form of paint shop seam sealers, underbody coatings, anti-chip coatings, roof ditch sealer and body shop sealers.

The composition of the present invention preferably comprises a urethane component, an epoxy component, a curing agent and a catalyst. Additionally, the composition preferably comprises a plasticizer and a solvent. Various fillers and additives may also be used.

The preferred composition includes blocked urethane prepolymers. The urethane prepolymer including polyester and polyether polyols and isocyanates (including toluene diisocyanate (TDI), diphenylmethane diisocyanate (MDI), hexamethylene diisocyanate (HDI), or isophorone diisocyanate (IPDI)) may be selected for the present composition. Curing agents including amines in powder form are preferred. Catalysts may be used and would preferably include any suitable catalyst in powder form. Such preferred catalyst include urea adducts. Preferred plasticizers include any of the phthalate ester types. Fillers may also be used to improve strength and resiliency. Where the composition includes an acrylic to improve physical properties, such acrylic is preferably in the form of powder.

In general, the epoxy-urethane or epoxy-urethane-acrylic compositions of the present invention demonstrate improved mechanical properties such as better lap shear strength, elongation, low temperature flexibility, and improved adhesion. Use of the compositions of the present invention lower production cost and virtually eliminates environmental impact issues. Both of these considerable advantages can be achieved while effecting high performance.

The compositions of the present invention also demonstrate greater mechanical and physical property design flexibility through use of urethane backbone. Compared with known urethane-acrylic technology, the overall improvement of the present invention over known compositions is illustrated by better general material performance and superior adhesion to a great variety of substrates. Improvements also recognized include improved low-temperature performance such as improved flexibility. Accordingly, the composition of the present invention reduces the need for an additional adhesion promoter in the formula compared to known technology.

### Background Chemistry

According to the present invention, two compositions are preferred, a urethane-epoxy hybrid, and a urethane-epoxy-acrylic hybrid. In each preferred composition, an amine in powder form is utilized as a curing agent.

Thus, the compositions may be based on either a urethane-epoxy system or on a urethane-epoxy-acrylic powder system. Amines are used to cure the liquid or solid epoxy resin and urethane mixture. The reactive components (the epoxy and the urethane) cross link into one molecular network at an elevated temperature. Conversely, known PVC-based plastisols only fuse when heated.

The principle composition elements are set forth hereinafter.

### Composition Elements

### Blocked Urethane Prepolymers

A variety of blocked urethane prepolymers may be used in the present composition, including urethane prepolymer prepared from polyester or polyether polyols and isocynates such as TDI, MDI, HDI, or IPDI and blocking agents including methylethylketoxime (MEKO) or others known to those skilled in the art. The blocked urethane prepolymer is preferably provided in an approximate amount of between about 10% and about 40% by weight. More preferably, the blocked urethane prepolymer is provided in an approximate amount of between about 11% and about 22% by weight.

### Epoxies

The particular epoxy is preferably selected from solid epoxy powders or liquids including reaction products of bisphenol-A and epichlorohydrin-based epoxy resins having a degree of polymerization of N=1 or greater. As a further alternative, aliphatic epoxy resins may also be used, however, such resins are generally more expensive and result in a less desirable hydrophilic system.

Suitable epoxies include DER 354, DER 331 and DER 662, all commercially available from The Dow Chemical Company.

The epoxy is preferably provided in an approximate amount of between about 5% and about 25% by weight. More preferably, the epoxy is provided in an approximate amount of between about 5% and about 15% by weight

### Curing Agents

A variety of curing agents in powder form may be used. It is preferred that the curing agents comprise amines. Suitable curing agents include Dicyandiamide (dicy), Adipic Dihyrazide (ADH), ANCAMINE 2014AS, ANCAMINE 2014FG, ANCAMINE 2337S, ANCAMINE 2441 and ANCAMINE 2442 may be used. Ancamine products are commercially available from Air Products and Chemicals, Inc. It is preferred that curing agents in powder form are used. Liquid curing agents such as liquid amines tend to be highly reactive at room temperature and less useful in the present invention. The curing agent is preferably provided in an approximate amount of between about 0.1% and about 10% by weight.

### Catalysts

Any suitable catalyst may be used. Again, catalysts in powder form are preferred. Catalysts such as urea adducts of the type used in one-component epoxy resin systems are preferred. The catalyst is preferably provided in an approximate amount of between about 0.1% and about 5% by weight.

It will be appreciated that certain compounds may act as both a catalyst and a curing agent as set forth in the examples below.

### Plasticizers

The plasticizer may be of any of the phthalate ester types such as Di-Isononylphthlate (DINP), Di-Isodecylphthlate (DIDP) or Palatinol® from BASF Corporation and may be of any type known to those skilled in the art of polyurethane elastomer formulations. The plasticizer is preferably provided in an approximate amount of between about 16% and about 50% by weight and more preferably, in an approximate amount of between about 16% and about 30% by weight.

### Fillers

Fillers are used, inter alia, to control rheology and to improve tensile strength, modulus strength, and sheer strength. In addition, fillers are used to improve abrasion resistance and to lower cost. Preferably, the fillers may be drawn from the group comprising of low cost calcium carbonated (treated PCC or ground), mica, talc, dolomite, clay, and carbon black. Other suitable cost lowering and rheology-controlling fillers can be used. The filler is preferably provided in an approximate amount of between about 25% and about 60% by weight. More preferably, the filler is provided in an approximate amount of between about 28% and about 40% by weight.

### Additives

Optional additives such as acrylic powders may be used in the present composition to provide known advantages. Acrylic powders are preferred and may be selected to provide physical strength. The acrylic powder, when used, is preferably provided in an approximate amount between about 5% and about 25% by weight. Other suitable additives may be used and, more preferably, in an approximate amount of between about 15% and about 20% by weight.

### Solvent

Suitable solvents may be used within the scope of the present invention. Preferably, odorless mineral spirits (OMS) is used as the solvent. Solvents may be present in an approximate amount of between about 1% and about 10% by weight and most preferably in an approximate amount of between about 4% and about 5% by weight.

The process of the present invention is illustrated by the following practical examples and comparative testing. All parts and percentages are by weight unless otherwise specified.

### Practical Example—Ditch Sealer (Urethane-Epoxy)

The table below shows both the composition elements for a urethane-epoxy composition according to the present invention. The described composition is directed to use preferably as a roof ditch sealer for paint shop. The composition utilizes a liquid epoxy.

| Name | Chemical | Weight % |
|---|---|---|
| 4045-15 | Blocked Urethane | 21.19 |
| | prepolymer | |
| Ancamine 2441 (modified | Catalyst/curative | 0.71 |
| amine) | | |
| ADH (adipic acid dihydrazide) | Curative | 1.18 |
| DER 354 | Liquid epoxy resin | 15.3 |
| Zinc octoate | Catalyst | 0.18 |
| Thixo-carb DA (calcium | Filler/rheology modifier | 28.25 |
| carbonate) | | |
| Drikalite (calcium carbonate) | Filler | 11.77 |
| OMS | Solvent | 4.94 |
| DINP | Plasticizer | 16.48 |
| | | 100.00 |
| Initial RVT | 10,900 cps | |
| Initial PF (press flow) | 83 second | |
| Specific gravity | 1.301 | |

RVT test conditions: #7 spindle, 20 rpm and 1 min (Brookfield Viscometer, Model RVT)
Press flow (PF) test conditions: 0.052″ orifice size, 40 psi and 20 gram material collected
All test samples were cured for 30 min at 285° F. then 30 min at 250° F. bake conditions
“Anacamine” is a registered trademark of Air Products and Chemicals, Inc.
“Drikalite” is a registered trademark of IMERYS

The press flow is an indication of the viscosity of the fluid. The press flow is the amount of time needed to press 20 g of material through an orifice. The pressure is processing parameters for the gun bar. Model RVT, Brookfield Viscometer is used to measure the material viscosity at low shear in the present invention. RVT numbers are parameters for material reology control.

### Processing Procedure—Example—Roof Ditch Sealer (Urethane-Epoxy)

The following procedure illustrates the steps for forming the roof ditch sealer set forth above according to the present invention. The procedure utilizes the components and weight percentages specified above in the above Practical Example. Each step of the processing procedure is carried out at ambient temperature.

| Step | Processing Procedure |
|---|---|
| 1 | Add 40415-15, blocked urethane prepolymer |
| 2 | Add DER 354 liquid epoxy resin |
| 3 | Add zinc octoate, catalyst |
| 4 | Add DINP plasticizer |
| 5 | Add ADH, curative |
| 6 | Add Ancamine 2441, catalyst/curative |
| 7 | Mix at low speed for 2 minutes |
| 8 | Add Drikalite, calcium carbonate filler |
| 9 | Mix at high speed for 2 minutes |
| 10 | Add Thixo-Carb DA, calcium carbonate filler/rheology modifier |
| 11 | Mix at high speed for 5 minutes |
| 12 | Add OMS solvent |
| 13 | Mix at high speed for 5 minutes |

The test sample was then cured at 285° F. for 30 minutes than at 250° F. for 30 minutes.

### Practical Example And Comparative Testing—Roof Ditch Sealer (Urethane-Epoxy-Acrylic)

The table below shows both the composition elements as well as comparative test results for a urethane-acrylic-epoxy composition according to the present invention. The described composition is directed to use preferably as a roof ditch sealer. The composition utilizes a liquid epoxy.

### PVC-Free Roof Ditch Sealer

| Name | Chemicals | Weight % |
|---|---|---|
| Dianal LP3106 | acrylic powder | 15.56 |
| 4045-15 | blocked urethane | 16.60 |
| | prepolymer | |
| Ancamine 2441 | curative | 0.41 |
| ADH(Adipate Hydrazide) | curative | 0.83 |
| DER 331 | liquid epoxy | 11.41 |
| Zinc Octoate | catalyst | 0.16 |
| Calcium Carbonate-Thixocab DA | filler | 11.41 |
| Drikalite | filler | 21.84 |
| OMS | solvent | 4.15 |
| DINP | Plasticizer | 17.63 |
| | | 100 |
| Critical Properties | | |
| Initial RVT | 65,000 cps | |
| Initial PF | 79 sec | |
| Specific Gravity | 1.18 | |
| lapshear strength | 341 psi | Cohesion failure |
| 2 mm spacer, 2 in/min pull | | |
| Bending, 0.5 inch diameter | pass | |
| −30° C. | | |

RVT test conditions: #7 spindle, 20 rpm and 1 min.
Press flow (PF) test conditions: 0.052″ orifice size, 40 psi and 20 gram material collected
All test samples were cured for 30 min at 285° F. then 30 min at 250° F. bake conditions
“Diana!” is a registered trademark of Mitsubishi Rayon Kabushiki Kaisha Corporation, Japan
“Ancamine” is a registered trademark of the Air Products and Chemicals, Inc.
“Drikalite” is a registered trademark of IMERYS

This sample was mixed and cured as set forth above in connection with the first sample. The lapshear strength was tested until there was a failure. The failure indicated was coheshion failure and not adhesion failure.

Practical Example And Comparative Testing—Seam Sealer—Solid Epoxy (Urethane-Epoxy-Acrylic)

The table below shows both the composition elements as well as comparative test results for a urethane-acrylic-epoxy composition according to the present invention. The described composition is directed to use preferably as a seam sealer. The composition utilizes a solid epoxy.

### PVC-Free Seam Sealer—Solid Epoxy

| Name | Chemicals | Weight % |
|---|---|---|
| Dianal LP3106 | additive | 20.02 |
| 4045-15 | blocked urethane | 11.59 |
| | prepolymer | |
| Ancamine2441 | curative/catalyst | 0.42 |
| ADH (Adipate Hydrazide) | curative | 0.37 |
| DER 662 | solid epoxy | 8.43 |
| | powder | |
| Zinc Octoate | catalyst | 0.16 |
| Calcium Carbonate-Thixocab DA | filler | 17.91 |
| Drikalite | filler | 10.54 |
| OMS | solvent | 4.21 |
| DINP | Plasticizer | 26.34 |
| | | 100 |
| Critical Properties | | |
| Initial RVT | 133,600 | |
| Initial PF | 82 | |
| Specific Gravity | 1.345 | |
| 10 Day @ 35 C. RVT | 15% Increase | |
| 10 Day @ 35 C. PF | 20% Increase | |
| 10 Day @ 35 C RVT | 10% Increase | |
| 10 Day @ 35 C. PF | 15% Increase | |
| Bending, 0.5 inch diameter | pass | |
| −20° C. | | |
| Bending, 0.5 inch diameter | Pass | |
| −30° C. | | |
| Lapshear strength | 330 psi | Cohesive failure |
| 2 mm spacer, 2 in/min pull | | |

RVT test conditions: #7 spindle, 20 rpm and 1 min.
Press flow (PF) test conditions: 0.052″ orifice size, 40 psi and 20 gram material collected
All test samples were cured for 30 min at 285° F. then 30 min at 250° F. bake conditions
“Diana!” is a registered trademark of Mitsubishi Rayon Kabushiki Kaisha Corporation, Japan
“Ancamine” is a registered trademark of the Air Products and Chemicals, Inc.
“Drikalite” is a registered trademark of IMERYS

This sample was mixed and cured as set forth above in connection with the first sample. The lapshear strength was tested until there was a failure. The failure indicated was coheshion failure and not adhesion failure.

Additionally, the composition was aged for 10 days at 35 ° C. The RVT and press flow of the initial and aged samples are shown.

### Practical Example & Comparative Testing—Seam Sealer—Liquid Epoxy (Urethane-Epoxy-Acrylic)

The table below shows both the composition elements as well as comparative test results for a urethane-acrylic-epoxy composition according to the present invention. The described composition is directed to use preferably as a seam sealer. The composition utilizes a liquid epoxy.

### PVC-Free Seam Sealer—Liquid Epoxy

| Name | Chemicals | Weight % |
|---|---|---|
| Dianal LP3106 | additive | 15.78 |
| 4045-15 | blocked urethane | 16.79 |
| | prepolymer | |
| Ancamine 2441 | catalyst | 0.81 |
| ADH (Adipate Hydrazide) | curative | 0.81 |
| DER 331 | Liquid epoxy | 11.7 |
| Zinc Octoate | curative catalyst | 0.15 |
| Calcium Carbonate-Thixocab DA | Filler | 21.37 |
| Drikalite | Filler | 10.18 |
| OMS | solvent | 4.07 |
| DINP | Plasticizer | 18.32 |
| | | 100 |
| Critical Properties | | |
| Initial RVT | 95000 cps | |
| Initial PF | 80 second | |
| S.G. | 1.18 | |
| 10 Day @ 35 C. RVT | 15% Increase | |
| 10 Day @ 35 C. PF | 20% Increase | |
| 10 Day @ 35 C. RVT | 10% Increase | |
| 10 Day @ 35 C. PF | 18% Increase | |
| Bending, 0.5 inch diameter | Pass | |
| −20° C. | | |
| Bending, 0.5 inch diameter | | |
| −30° C. | | |
| Lapshear | 345 psi | Cohesive failure |
| 2 mm spacer, 2 in/min pull | | |

RVT test conditions: #7 spindle, 20 rpm and 1 min.
Press flow (PF) test conditions: 0.052″ orifice size, 40 psi and 20 gram material collected
All test samples were cured for 30 min at 285° F. then 30 min at 250° F. bake conditions
“Diana!” is a registered trademark of Mitsubishi Rayon Kabushiki Kaisha Corporation, Japan
“Ancamine” is a registered trademark of the Air Products and Chemicals, Inc.
“Drikalite” is a registered trademark of IMERYS

This sample was mixed and cured as set forth above in connection with the first sample. The lapshear strength was tested until there was a failure. The failure indicated was cohesion failure and not adhesion failure.

Additionally, the composition was aged for 10 days at 35° C. The RVT and press flow of the initial and aged samples are shown.

### General Test Results

General test results of the PVC-free plastisols of the present invention demonstrate excellent physical performance after curing in conventional bake ovens. These good characteristics include improved physical strength, elongation, sealing/bridging, and storage stability. Additional positive characteristics include improved adhesion to e-coated substrates and good compatibility with primer and top coatings.

The compositions of the present invention also demonstrate improved rheological properties when compared with the prior art. Specifically, the rheological properties of compositions formed according to the teachings of the present invention are more consistent over the shelf life of the product and, accordingly, application of the product will be more consistent over the shelf life of the product. Because the epoxy-urethane hybrid of the present invention requires a relatively high activation temperature (>250° F.) to initiate curing the compositions of the present invention are not limited to the 60 to 90 day shelf life of known compositions.

It is understood that the above are merely preferred embodiments and that various changes and alterations can be made without departing from the spirit and broader aspects of the invention.

What is claimed is:

1. A one-component composition adapted for use as a sealer comprising:
a urethane component;
an epoxy component;
a curing agent component; and
a catalyst component wherein the composition has an activation temperature of at least 250° F. to initiate curing of the composition.

2. The composition of claim 1 wherein said urethane component comprises a blocked urethane pre-polymer and is provided in the amount of between about 10% and about 40% by weight.

3. The composition of claim 2 wherein said blocked urethane pre-polymer is provided in an amount of between about 11% and about 22% by weight.

4. The composition of claim 1 wherein said epoxy component is selected from the group comprising solid epoxy powders and liquids including reaction products of bisphenal-A and epichlorhydrin based epoxy resins having a degree of polymerization of N=1 and greater, and aliphatic epoxy resins.

5. The composition of claim 4 wherein said epoxy component is provided in the amount of between about 5% and about 25% by weight.

6. The composition of claim 5 wherein said epoxy component is provided in an amount of about between about 5 and about 15% by weight.

7. The composition of claim 1 wherein said curing agent component comprises an amine in powder form.

8. The composition of claim 7 wherein said curing agent is provided in the range at between about 0.1% and about 10% by weight.

9. The composition of claim 1 wherein said catalyst component comprises urea adducts in powder form.

10. The composition of claim 9 wherein said catalyst component is provided in the amount of between about 0.1% and about 5.0% by weight.

11. The composition of claim 1 further including an additive comprising acrylic powders.

12. The composition of claim 11 wherein said additive is provided in the amount of between 5% and about 25% by weight.

13. The composition of claim 1 further comprising a plasticizer component comprising a phthalate ester.

14. The composition of claim 13 wherein said plasticizer component is provided in the amount of between about 16% and about 50% by weight.

15. The composition of claim 14 wherein said plasticizer is provided in the amount of between about 16% and about 30% by weight.

16. The composition of claim 1 further comprising a filler wherein said filler component is provided in the amount of between about 20% and about 60% by weight.

17. The composition of claim 1 further comprising a solvent.

18. The composition of claim 17 wherein said solvent comprises odorless mineral spirits.

19. The composition of claim 18 wherein said solvent is provided in the amount of between about 1% and about 10% by weight.
